(19) United States
(12) Patent Application Publication
(10) Pub. No.: US 2018/0148894 A1
(43) Pub. Date: May 31, 2018

(54) Use of a strength composition for increasing wet dimensional stability of a moulded pulp article

(71) Applicant: KEMIRA OYJ, Helsinki (FI)

(72) Inventors: Jan-Luiken HEMMES, Bergisch Gladbach (DE); Jonathan WEI, Shanghai (CN); Rongjun LU, Shanghai (CN)

(73) Assignee: Kemira Oyj, Helsinki (FI)

(21) Appl. No.: 15/568,478

(22) PCT Filed: Apr. 21, 2016
(86) PCT No.: PCT/FI2016/050261

§ 371 Date: Oct. 21, 2017

(30) Foreign Application Priority Data
Apr. 21, 2015 (CN) 201510190683.6
May 5, 2015 (FI) 20155325

(51) Int. Cl. D21C 5/02; D21J 7/00; D21J 3/00; D21J 1/08; C08G 73/02

(52) U.S. Cl. CPC D21C 5/02; D21J 7/00; C08G 73/02; D21J 1/08; D21J 3/00

(57) ABSTRACT

The invention relates to a use of a strength composition for increasing wet dimensional stability of a moulded pulp article. The moulded pulp article is produced by a method which comprises obtaining a fibre slurry and feeding it to a forming tank of a moulding apparatus, forming a moulded pulp article from the fibre slurry, and drying the moulded pulp article. The strength composition comprises at least one permanent wet strength resin and the strength composition is added to the fibre slurry before the forming of the moulded pulp article.

The present invention relates to a use of a strength composition for increasing wet dimensional stability of a moulded pulp article according to the preambles of enclosed claims.

Moulded pulp articles are made by preparing a fibre slurry, typically from recycled fibre material, and placing the slurry into a mould. The mould usually comprises perforations and/or mesh, and suction and/or vacuum is used to create an even coat of slurry in the mould. After this the formed moulded article is dried, for example in a separate dryer, or by heating the mould itself.

Moulded pulp articles are widely used for variety of purposes such as packaging material, egg cartons, food service trays, beverage carriers, clamshell containers, plates, and bowls. Lately, it has been proposed that moulded pulp articles can be used even for making moulds, which are used in casting of concrete structures and/or products. It is clear that the above-mentioned use require dimensional stability and physical strength from the moulded pulp articles even when they are wetted. Therefore there exists an immediate need for improving the wet dimensional stability of moulded pulp articles, especially in strongly alkaline environment.

An object of this invention is to minimise or possibly even eliminate the disadvantages existing in the prior art.

Another object of the present invention is to provide a cost-effective method for increasing wet dimensional stability and/or physical strength of a moulded pulp article, especially in strongly alkaline environment.

These objects are attained with the invention having the characteristics presented below in the characterising parts of the independent claims.

Some preferred embodiments of the invention are presented in the dependent claims.

In a typical use for a strength composition according to the present invention for increasing wet dimensional stability of a moulded pulp article, the moulded pulp article is produced by a method which comprises
obtaining a fibre slurry and feeding it to a forming tank of a moulding apparatus,
forming a moulded pulp article from the fibre slurry,
drying the moulded pulp article,

wherein the strength composition comprises at least one permanent wet strength resin and the strength composition is added to the fibre slurry before the forming of the moulded pulp article.

Now it has been surprisingly found that the wet three-dimensional stability and the physical strength of a moulded pulp article, especially in strongly alkaline environment, is significantly improved when a strength composition comprising at least one synthetic permanent wet strength resin is added to the fibre slurry before the formation of the moulded article. It is assumed that, without wishing to be bound by a theory, the addition of the strength composition into the slurry provides so strong interaction between the strength resin and the fibres during the formation of the moulded article that it provides improved stability and strength even in demanding environment with e.g. strong alkaline nature.

Furthermore, it has been observed that especially the long term wet three-dimensional stability and physical strength of the moulded article are improved. Thus the moulded article is able to retain is physical strength and physical dimensions unaltered or nearly unaltered for prolonged periods of time, e.g. for several hours, preferably for several days, sometimes even for several months, even if the moulded article is exposed to a strongly alkaline environment. According to one embodiment of the invention, the moulded pulp produced by the present method may have a wet tensile strength index >2 Nm/g, preferably >4 Nm/g, more preferably >10 Nm/g. The tensile strength is measured by using hand sheets, having a basis weight of 100 g/m², made from the pulp after addition of the strength composition.

In the present context, the term “strongly alkaline environment” denotes an environment, where the pH is in the range of 10-14, typically 11-14, more typically 12-14. These pH ranges are commonly present in casting of concrete. The present invention provides improved moulded pulp articles that retain their three-dimensional shape and strength even in strongly alkaline environment, preferably for prolonged periods as described above. This makes the articles suitable for use as mould in casting of concrete structures.

The fibre slurry may be obtained by disintegrating fibre material into water. The fibre slurry may comprise fibre material originating from recycled paper and/or board, such as old corrugated containerboard (OCC). Preferably the fibre material is OCC. According to one preferred embodiment the fibre material comprises at least 70 weight-%, preferably at least 80 weight-% of fibres originating from recycled paper or board, such as OCC. In some preferable embodiments the fibre stock may comprise even >90 weight-%, preferably even 100 weight-%, of fibres originating from recycled paper or board, such as OCC. The fibre slurry is feed to a forming tank of a moulding apparatus.

The permanent wet strength resin may be a cross-linked resin. Preferably the permanent wet strength resin may be selected from polyamidoamine-epihalohydrin resins or polydiisocyanate resins. It has been observed that especially polyamidoamine-epihalohydrin resins and polydiisocyanate resins provide improved properties, especially wet three-dimensional stability, in strongly alkaline environments.

According to one preferable embodiment of the invention the permanent wet strength resin is a self-crosslinking polyamidoamine-epihalohydrin resin. Polyamidoamine-epihalohydrin resins are based on a polyamidoamine backbone, which is a result of a condensation reaction between adipic acid and diethylenetriamine. A subsequent reaction with epihalohydrin results a crosslinked polymer resin structure, where highly reactive azetidinium groups are created along the polymer backbone. According to one embodiment the polyamidoamine-epihalohydrin resin may have an azetidinium content of <80%, preferably <70%, more preferably <60%, even more preferably <50%, sometimes even <40%. According to one embodiment, the polyamidoamine-epihalohydrin resin may have an azetidinium content in the range of 0.01-80%, preferably 0.01-70%, more preferably 0.01-60%, even more preferably 0.01-50%, sometimes even 0.01-40%.

The amount of azetidinium groups may be controlled by careful selection, for example, of the epihalohydrin/amine ratio. According to one exemplary embodiment, the polyamidoamine-epihalohydrin resin has an epihalohydrin/amine ratio of <0.8, preferably <0.5, more preferably <0.45, even more preferably <0.4, sometimes even <0.3. The lower limit for this epihalohydrin/amine ratio may be 0.1, preferably 0.01. According to one embodiment the resin may have the epihalohydrin/amine ratio in the range of 0.01-0.8, preferably 0.01-0.5, more preferably 0.01-0.45, even more preferably 0.01-0.4, sometimes even 0.01-0.3. The epihalohydrin/amine ratio is calculated as the molar ratio of epihalohydrin to amine.

Suitable polyamidoamine-epihalohydrin resins may have a weight average molecular weight in the range of 80 000-250 000 g/mol, preferably 150 000-250 000 g/mol. The molecular weight is determined by size exclusion chromatography, using poly(2-vinylpyridine) as calibration standard.

As described above polyamidoamine-epihalohydrin resins have a significant amount of reactive azetidinium groups, which provide the resin with a high cationic charge, which improves the retention of the resin to the fibres and provides the resin with a self-crosslinking ability. Preferably the polyamidoamine-epihalohydrin resin has a charge density of 1.5-4.5 meq/g, preferably 2.0-4.0 meq/g, more preferably 2.1-3.0 meq/g, determined at pH 7 by titration with potassium salt of polyvinylsulfate. When retained in the moulded pulp article the polyamidoamine-epihalohydrin resin self-crosslinks and forms a strong protection around fibre-fibre bonds and prevents the bonds from hydrolysing, even in alkaline environment.

Preferably the permanent wet strength resin is polyamidoamine-epichlorohydrin.

According to one preferable embodiment of the invention the permanent wet strength resin is a polydiisocyanate resin. Polydiisocyanate resin is preferably used in form of an aqueous emulsion in order to provide an even distribution of the resin to the fibre slurry. Polydiisocyanate resin may comprise an aliphatic, cycloaliphatic or aromatic polydiisocyanate, or a mixture thereof. Suitable polydiisocyanates may comprise, preferably, more than 2 isocyanate groups, for example 2 to 5 isocyanate groups. Preferable examples of polydiisocyanate resins are based on diphenylmethane diisocyanate, toluene diisocyanate, hexamethylene diisocyanate and isophorone diisocyanate chemistry. The amount of reactive isocyanate groups, i.e. NCO-content, may vary in the range of 5-50%, typically 7-25%.

According to one preferred embodiment the strength composition comprises both polyamidoamine epihalohydrin resin and anionic polyacrylamide. The anionic polyacrylamide may improve the retention of the permanent wet strength resin to the fibres. The ratio of the anionic polyacrylamide and polyamidoamine epihalohydrin resin may be about 0.05 to 1.

The strength composition is added to the pulp slurry before the formation of the moulded pulp article, for example during the manufacture of the pulp slurry, its storage or transport. The strength composition may be added into a pulper, pulp storage tank or to a forming tank of the moulding apparatus.

According to one preferred embodiment of the present invention the strength composition is added in such amount that the zeta potential of the fibre slurry remains <−2.0 mV after the addition of the strength composition. When the zeta potential approaches too close to neutral value, foaming may become a problem. Therefore it is preferred that the strength agent composition is added in amount the zeta potential of the fibre slurry is <−3.0 mV, more preferably <−5 mV, even more preferably <−10 mV after the addition of the strength composition.

The strength composition may be added in amount that results 1.3-26 kg permanent wet strength resin/ton dry fibre slurry, preferably 2.6-18.2 kg permanent wet strength resin/ton dry fibre slurry, more preferably 3-15 kg permanent wet strength resin/ton dry fibre slurry, even more preferably 5.2-13 kg permanent wet strength resin/ton dry fibre slurry, sometimes even 5.2-11 kg permanent wet strength resin/ton dry fibre slurry, calculated as dry permanent wet strength resin. It was unexpectedly observed that the improvement in wet three-dimensional stability and physical strength of the moulded article can be achieved even with relative low dosage of the strength composition. This is advantageous, not only because thus the above-mentioned problems associated with neutral zeta potential values may be avoided, but also because the chemical costs may be minimized in the process.

According to one embodiment of the invention a defoaming agent may be added to the fibre slurry. The defoaming agent may be added before the addition of the strength composition. The defoaming agent may be selected from silica based defoaming agents and defoaming agents based on fatty alcohols. Typically the defoaming agent is added in amount of 200-500 g/ton of dry fibre slurry, preferably 200-300 g/ton of dry fibre slurry, more preferably 200-250 g/ton of dry fibre slurry.

According to one preferable embodiment the strength composition further comprises a hydrophobic agent. The hydrophobic agent may be alkyl ketene dimer wax or paraffin wax, preferably alkyl ketene dimer wax. Suitable alkyl ketene dimer wax may have a melting point in the range of 40-70° C., preferably 44.5-64° C., more preferably 44.5-49° C. The amount of hydrophobic agent may be 0.1-20 weight-%, preferably 2-17 weight-%, more preferably 5-15 weight-% from the weight of the wet strength resin, calculated as dry and active.

According to one embodiment the fibre slurry is free from inorganic particles, such as fillers or colouring pigments.

According to one embodiment of the invention the moulded pulp article is allowed to dry naturally in the atmosphere after its formation. For example, the moulded pulp article is allowed to dry 10-24 h, preferably 15-20 h, before the thermoforming treatment. After natural drying the mould pulp article is thermoformed in a hot press by using a temperature above 150° C.

According to one preferable embodiment of the present invention the produced moulded pulp articles are used in manufacture of concrete products and structures. The moulded pulp article can be a cast mould or pod for forming of concrete articles and/or structures, for example when casting concrete floors, building foundations or similar structures.

### EXPERIMENTAL

Some embodiments of the invention are described in the following non-limiting examples.

### Example 1

Commercial Old Corrugated Container (OCC) pulp slurry, concentration 5 weight-%, was used as recycled fibre raw material. Two different polyamidoamine-epichlorohydrin (PAE) based wet strength resins (Kemira Oyj, Finland), denoted here as Fiberbuilder A and Fiberbuilder B, were used to improve hand sheet strength. Properties of the wet strength resins are given in Table 1. Alkylketene dimer wax (Kemira Oyj, Finland) was used in some of the experiments together with the wet strength resins.

TABLE 1
Properties of the wet strength resins employed in the experiments.

| Chemical | Solids content, % | PCD (meq/g) | pH |
|---|---|---|---|
| Fiberbuilder A | 26.32 | 2.52 | 3.88 |
| Fiberbuilder B | 26.60 | 2.93 | 3.72 |

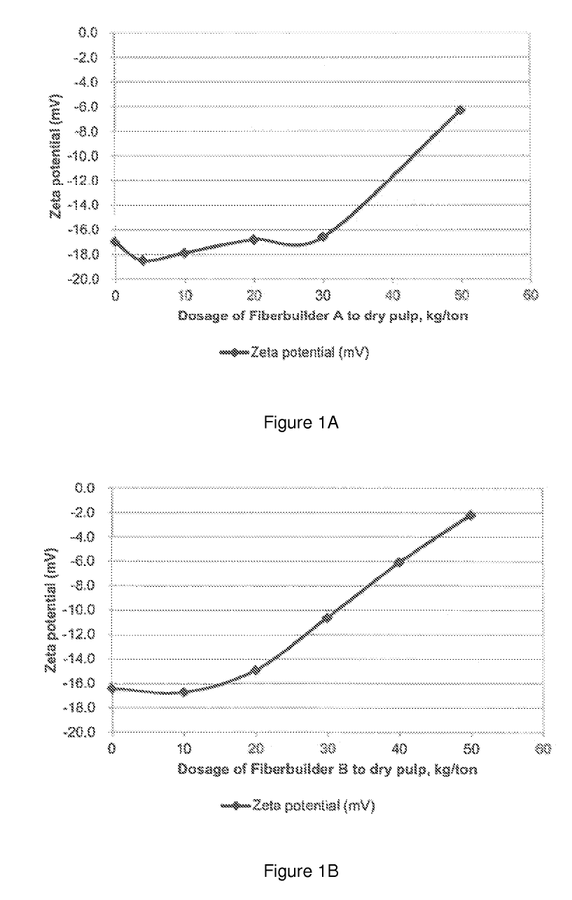

Capability of the fibres to retain wet strength resin was evaluated based on Zeta potential of the fibre slurry, which was measured by using Mütek SZP-6. Effect of the strength resin dosage on the Zeta potential of the fibre slurry is shown in FIGS. 1A and 1B. It is from FIGS. 1A and 1B that an increasing dosage of wet strength resin increases the Zeta potential of the fibre slurry.

The original deflaked OCC pulp was diluted into 1 weight-% concentration with tap water under agitation. The used chemicals were dosed into the pulp slurry of disintegrated OCC. Wet strength resin dosage was 10 kg/t, 30 kg/t or 50 kg/t, and the AKD dosage was 0 kg/t or 5 kg/t. The prepared pulp slurry was first agitated at about 500 rpm for 15 seconds, and then the used chemicals were dosed with an interval of 15 seconds each. After dosing, the mixing of the pulp slurry was continued for 15 seconds. Hand sheets, having a basis weight of 100 g/m², were produced on a hand sheet maker machine. Sheets were dried in automatic drying chambers of hand sheet maker machine for 6 minutes at the temperature of 93° C. and vacuum of 96 kPa to rapidly remove the moisture.

Before testing of the strength properties, of the produced hand sheets, i.e. dry tensile index and dry tensile index, the sheets were pre-conditioned for 24 h at 23° C. in 50% relative humidity according to standard ISO 187. Devices and standards, which were used to measure the properties of the sheets, are given in Table 2.

TABLE 2
Sheet testing devices and standards

| Measurement | Device | Standard |
|---|---|---|
| Hand sheet | Estanit Rapid Köthen hand sheet | ISO 5269-2-2004 |
| making | maker | |
| Wet tensile index | Thwing-Albert vertical tensile tester | GB/T 12914-2008 |
| Dry tensile index | Thwing-Albert vertical tensile tester | GB/T 12914-2008 |

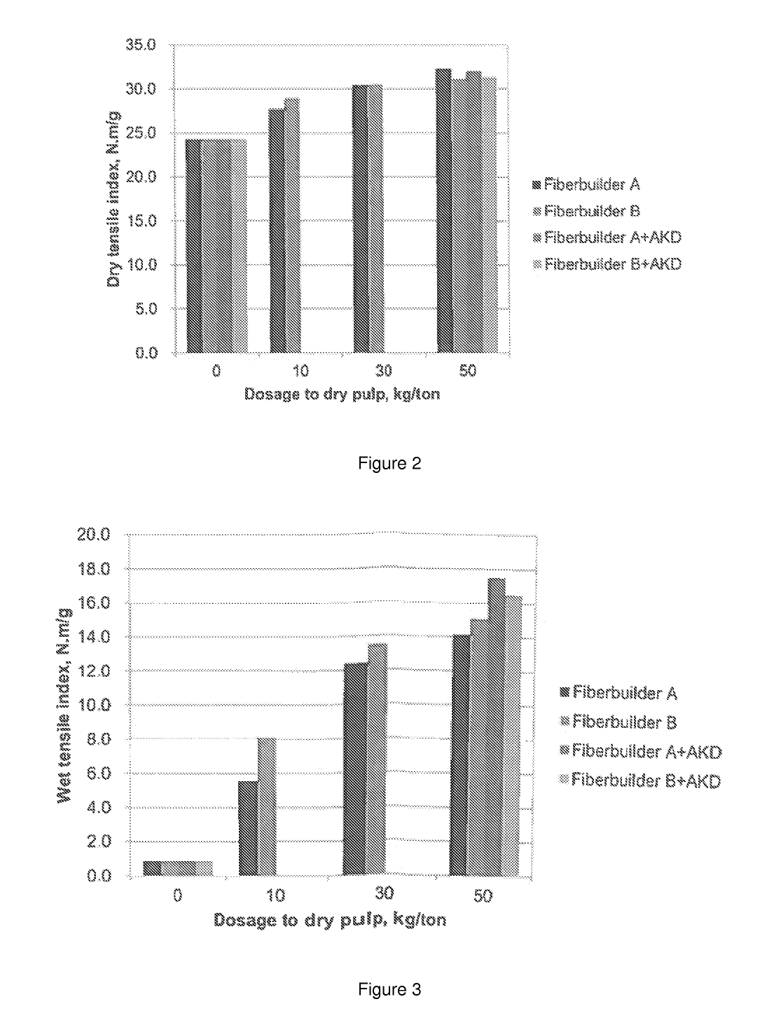

The wet tensile index and dry tensile index results at different wet strength resin and AKD dosages are shown in FIGS. 2 and 3. It is seen from FIGS. 2 and 3 that a very good wet tensile index results were obtained. Also an improvement in dry tensile index was observed. For dry tensile index the difference between the results obtained with Fiberbuilder A or Fiberbuilder B was not big. However, it was observed that Fiberbuilder B gave better wet tensile index results than Fiberbuilder A. AKD addition provided extra enhancement, for both wet strength resins.

### Example 2

Based on the laboratory test of Example 1 Fiberbuilder B was selected for further tests in a pilot scale experiment at a mill producing moulded pulp articles. Fiberbuilder B was tested both together with AKD and without AKD. Test plan is given in Table 3.

TABLE 3
Test plan for pilot scale experiments

| Test | | Dosage | |
|---|---|---|---|
| No | Chemical(s) | kg/ton | Box No. |
| 1 | AKD | 60 | 1, 2, 3 |
| 2 | Fiberbuilder B | 30 | B1, B2 |
| 3 | Fiberbuilder B + AKD | 30 + 5 | B3, B4 |
| 4 | Fiberbuilder B | 50 | B5, B6 |
| 5 | Fiberbuilder B + AKD | 50 + 5 | B7, B8 |

In Test no 1 the used AKD solution had a solid content of 13%. For Box 2 AKD was added to the slurry and for Box 3 the AKD was applied as a coating.

The production process for the moulded pulp articles was as follows:
1. Preparation of about 5 weight-% fiber slurry recycled fluting board in a pulper, the preparation takes about 5-6 min;
2. Transfer of the fibre slurry into 10 m³ pulp storage tank, where the pulp slurry is diluted from the concentration of 5 weight-% to about 1 weight-%;
3. Pumping about 500 litres of pulp slurry to a forming tank of a moulding machine, dewatering and moulding of boxes;
4. Drying in the atmosphere, thermoforming and making of the final articles with hot press, where the temperature is about 180 to 190° C.

In these tests the strength composition/wet strength agents were added into the forming tank of the moulding machine and manual agitation for 5 min was employed before the forming of the article. Natural drying in the atmosphere lasted for 16 hours before thermoforming.

Table 4 lists the weight of the boxes before and after the thermoforming treatment.

TABLE 4
Weight of the boxes before (wet weight) and after thermoforming
(dry weight).

| | Wet weight | Dry weight | Processing time |
|---|---|---|---|
| Box No. | (kg) | (kg) | (mm) |
| 1 | — | 5.5 | — |
| 2 | — | 5.5 | — |
| 3 | — | 5.4 | — |
| B1 | 11.0 | 5.0 | 21 |
| B2 | 10.1 | 4.8 | 21 |
| B3 | 10.4 | 5.1 | 20 |
| B4 | 10.1 | 5.0 | 20 |
| B5 | 11.6 | 5.8 | 20 |
| B6 | 10.1 | 5.0 | 20 |
| B7 | 11.5 | 5.8 | 20 |
| B8 | 10.8 | 5.3 | 19.5 |

After the thermoforming the boxes were cooled down, and a series of performance tests were conducted to test the physical strength and dimensional stability of the boxes. Boxes 1, 2, 3, B2, B3, B6, B8 were chosen for the performance test series.

1. Performance Test 1

All the boxes were arranged in a row and 80 kg weight was put on top of each box for about 10 seconds. All the boxes were stable.

2. Performance Test 2

Tap water was sprayed onto the boxes for 15 min, then 80 kg weight was put on top of each box for about 10 seconds. All the boxes were stable, but Box 1 seemed to be slightly softer than the others. After that a gasket was put on top of the boxes and 80 kg weight was put on the gasket to increase the intensity of pressure. Both the center and the border of the top face of each box were tested. Box 1 broke but the other boxes were still stable.

3. Performance Test 3

Spraying of tap water was continued onto the boxes for another 15 min, which makes the total spraying time to 30 min. After spraying 80 kg weight was again put on top of each box for about 10 seconds. All the boxes were stable. After that a gasket was put on top of the boxes and 80 kg weight was put on the gasket to increase the intensity of pressure. Both the center and the border of the top face of each box were tested. Box 3 broke but the other boxes were still stable.

4. Performance Test 4

All the remaining boxes were enveloped with a plastic film to simulate wet environment and keep for 2 hours. Then 80 kg weight was put on top of each box for about 10 seconds. At this stage, Box 2 broke. Then a gasket was put on top of the boxes and 80 kg weight was put on the gasket to increase the intensity of pressure. At this stage, Box B3 broke. Box B2 was softer than Boxes B6 and B8, which still showed satisfactory strength properties and dimensional stability.

Thus it can be concluded that a 50 kg/ton dosage of Fiberbuider B gave satisfactory wet strength properties and dimensional stability.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A method for increasing wet three-dimensional stability of a moulded pulp article in an alkaline environment by using a strength composition, wherein the method comprises the steps of
obtaining a fibre slurry and feeding it to a forming tank of a moulding apparatus,
adding the strength composition to the fibre slurry,
forming a moulded pulp article from the fibre slurry,
drying the moulded pulp article,
wherein
the strength composition comprises at least one permanent wet strength resin.

2. The method according to claim 1, wherein pH of the alkaline environment is in the range of 10-14, typically 11-14, more typically 12-14.

3. The method according to claim 1, wherein the permanent wet strength resin is a cross-linked resin and selected from polyamidoamine-epihalohydrin resins or polydiisocyanate resins.

4. The method according to claim 1, wherein the strength composition comprises wet strength resin, which is polyamidoamine-epihalohydrin resin.

5. The method according to claim 4, wherein the polyamidoamine-epihalohydrin resin has an azetidinium content of <80%, preferably <70%, more preferably <60%, even more preferably <50%.

6. The method according to claim 4, wherein the polyamidoamine-epihalohydrin resin has a charge density of 1.5-4.5 meq/g, preferably 2.0-4.0 meq/g, more preferably 2.1-3.0 meq/g.

7. The method according to claim 1 wherein the strength composition is added in such amount that the zeta potential of the fibre slurry remains <−2.0 mV after the addition of the strength composition.

8. The method according to claim 1 wherein the strength composition is added in amount that results 1.3-26 kg permanent wet strength resin/ton dry fibre slurry, preferably 2.6-18.2 kg permanent wet strength resin/ton dry fibre slurry, more preferably 3-15 kg permanent wet strength resin/ton dry fibre slurry, even more preferably 5.2-13 kg permanent wet strength resin/ton dry fibre slurry.

9. The method according to claim 1 wherein the strength composition is added into added into a pulper, pulp storage tank or into the forming tank of the moulding apparatus.

10. The method according to claim 1 wherein the strength composition comprises polyamidoamine-epihalohydrin resin and anionic polyacrylamide, preferably the ratio of the anionic polyacrylamide and polyamidoamine-epihalohydrin resin being 0.05 to 1.

11. The method according to claim 1 wherein the strength composition further comprises a hydrophobic agent, which is selected from alkyl ketene dimer wax or paraffin wax.

12. The method according to claim 11, wherein the amount of hydrophobic agent is in the range of 0.1-20 weight-%, preferably 2-17 weight-%, more preferably 5-15 weight-%, from the weight of the wet strength resin.

13. The method according to claim 1 wherein the fibre slurry comprises fibre material originating from recycled paper or board, such as old corrugated containers (OCC).

14. The method according to claim 13, wherein the fibre material comprises at least 70 weight-%, preferably at least 80 weight-% of fibres originating from recycled paper or board.

15. The method according to claim 1 wherein the finished moulded pulp article is a cast mould or pod for forming of concrete articles and/or structures.
